(19) United States
(12) Patent Application Publication
(10) Pub. No.: US 2012/0008237 A1
(43) Pub. Date: Jan. 12, 2012

(54) WIDE-BANDWIDTH DIELECTRIC WINDOWING FOR CONDUCTOR SUSPENSION STRUCTURE

(76) Inventors: John Thomas Contreras, Palo Alto, CA (US); Bruce Alvin Gurney, San Jose, CA (US); Nobumasa Nishiyama, Yokohama-city (JP)

(21) Appl. No.: 12/832,531

(22) Filed: Jul. 8, 2010

(51) Int. Cl. G11B 5/60

(52) U.S. Cl. 360/234.5; G9B/5.229

(57) ABSTRACT

Approaches for a hard-disk drive suspension interconnect having a wide bandwidth. A suspension interconnect includes a substrate layer, a dielectric layer disposed on the substrate layer, and a plurality of transmission-line (TL) conductors disposed within the dielectric layer. Air gaps may be disposed around the TL conductors to minimize the tendency of the dielectric material to act as an electrical shunt, which impedes high bandwidth signal transmission. An air gap may exist in the dielectric layer between adjacent TL conductors. Additionally, the area adjacent to the plurality of TL conductors, along the direction of signal travel, may alternate between dielectric material and air gaps. Indeed, there need not be any solid material enclosing the TL conductors save for a plurality of dielectric cross ties that provide structural support thereto. The substrate layer may also comprise one or more air gaps underneath a portion of the plurality of TL conductors.

### FIELD OF THE INVENTION

Embodiments of the invention generally relate to a suspension interconnect structure that supports high frequency signal transmission.

### BACKGROUND OF THE INVENTION

A hard-disk drive (HDD) is a non-volatile storage device that is housed in a protective enclosure and stores digitally encoded data on one or more circular disks having magnetic surfaces (a disk may also be referred to as a platter). When an HDD is in operation, each magnetic-recording disk is rapidly rotated by a spindle system. Data is read from and written to a magnetic-recording disk using a read/write head which is positioned over a specific location of a disk by an actuator.

A read/write head uses a magnetic field to read data from and write data to the surface of a magnetic-recording disk. As a magnetic dipole field decreases rapidly with distance from a magnetic pole, the distance between a read/write head and the surface of a magnetic-recording disk must be tightly controlled. To provide the distance between a read/write head and the surface of a magnetic-recording disk, an actuator relies on suspension's force on the read/write head to provide the proper distance between the read/write head and the surface of the magnetic-recording disk while the magnetic-recording disk rotates. A read/write head therefore is said to “fly” over the surface of the magnetic-recording disk. When the magnetic-recording disk stops spinning, a read/write head must either “land” or be pulled away onto a mechanical landing ramp from the disk surface.

A write-head of an HDD records data onto the surface of a magnetic-recording disk in a series of concentric tracks. Electrical signals may be carried by electrical conductors (or “traces”) within the HDD to a transducer of the read/write head. The transducer converts the electrical signals, carried by the electrical conductors, into a magnetic write field used to write data to a track on the magnetic-recording disk. The greater the frequency (the “write frequency”) of the magnetic write field, the greater the amount of data that can be stored on the track (referred to as recording density) and the faster the data can be retrieved. It is desirable to store as much data as is safely possible on a magnetic-recording disk. For reading data, a read transducer translates the magnetic signals into electrical signals, which are then carried by electrical conductors (or “traces”) within the HDD to signal processing electronics.

### SUMMARY OF THE INVENTION

Until recently, the electrical signals and harmonics received by the transducers which generate the magnetic write fields within a hard-disk drive (HDD) typically did not exceed 4 gigahertz. However, in the future, HDDs may enable or require transducers to receive and/or transmit electrical signals with much higher frequency, such as 10-30 gigahertz.

It is observed that today's transmission-line (TL) conductors on the suspension (also referred to as “traces”) within a HDD cannot scale to support higher frequency signals. This is so because, when the transmission-line (TL) conductors conduct signals at higher frequencies, the dielectric material which insulates the transmission-line (TL) conductors itself becomes conductive, thereby causing the dielectric material to act as an electrical shunt that dissipates energy carried by the transmission-line (TL) conductors.

Advantageously, embodiments of the invention address this issue by reducing or eliminating the dielectric material surrounding, enclosing, or adjacent to the transmission-line (TL) conductors. Embodiments may dispose one or more of air gaps along adjacent transmission-line (TL) conductors (sometimes referred to as an “air spine”), may dispose air gaps in the substrate layer beneath the transmission-line (TL) conductors (sometimes referred to as “substrate windowing”), and may remove the dielectric material adjacent to the transmission-line (TL) conductors except for support structures (referred to as “cross ties”) made out of dielectric material. By reducing or eliminating the dielectric material surrounding, enclosing, or adjacent to the transmission-line (TL) conductors in this manner, the ability of the dielectric material to act as an electrical shunt is reduced, thereby allowing the transmission-line (TL) conductors to support a greater amount of signal bandwidth.

Embodiments discussed in the Summary of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a plan view of an HDD according to an embodiment of the invention;

FIG. 2 is a plan view of a head-arm-assembly (HAA) according to an embodiment of the invention;

FIG. 3 is a cross-sectional view of a prior art interconnect structure according to the prior art;

FIG. 4A is a cross-sectional view of an interconnect structure having an air spine;

FIG. 4B is a top view of an interconnect structure having an air spine;

FIG. 5A is a top view of an interconnect structure having dielectric cross ties according to an embodiment of the invention;

FIG. 5B is a top view of a interconnect structure having an air spine, dielectric cross ties, and substrate windows according to an embodiment of the invention; and

FIG. 6 is a graph comparing the frequency response for different approaches according to embodiments of the invention.

### DETAILED DESCRIPTION OF THE INVENTION

Approaches for reducing or eliminating the dielectric material surrounding, enclosing, or adjacent to the transmission-line (TL) conductors to increase the signal bandwidth supported by the transmission-line (TL) conductors are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

Physical Description of Illustrative Embodiments of the Invention

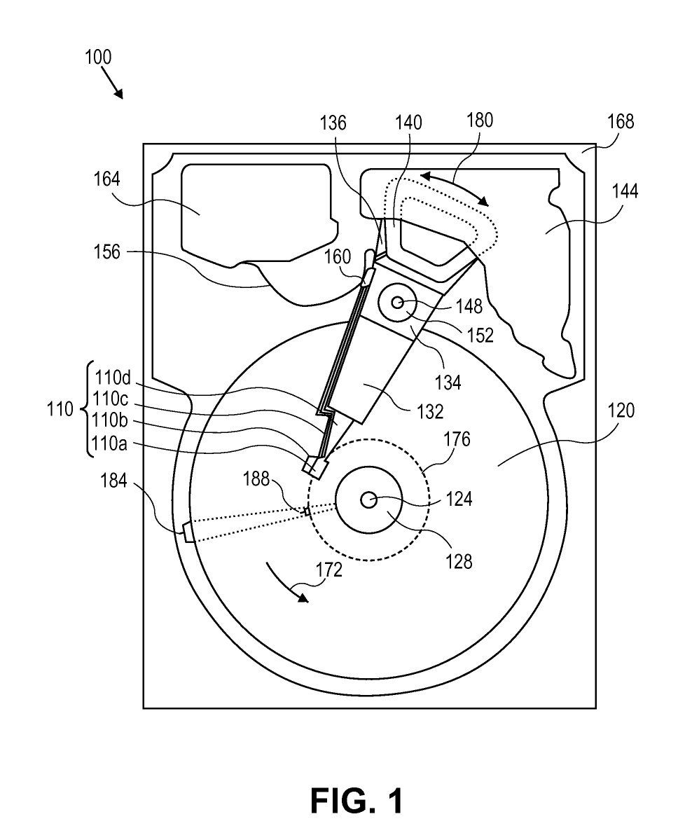

While embodiments of the invention may be implemented in a variety of electrical equipment, particular embodiments of the invention shall be described with reference to a hard-disk drive (HDD). In accordance with an embodiment of the present invention, a plan view of a HDD 100 is shown in FIG. 1. FIG. 1 illustrates the functional arrangement of components of the HDD including a slider 110b that includes a magnetic-recording head 110a. The HDD 100 includes at least one head gimbal assembly (HGA) 110 including the head 110a, a lead suspension 110c attached to the head 110a, and a load beam 110d attached to the slider 110b, which includes the head 110a at a distal end of the slider 110b; the slider 110b is attached at the distal end of the load beam 110d to a gimbal portion of the load beam 110d. The HDD 100 also includes at least one magnetic-recording disk 120 rotatably mounted on a spindle 124 and a drive motor (not shown) attached to the spindle 124 for rotating the disk 120. The head 110a includes a write element and a read element for respectively writing and reading information stored on the disk 120 of the HDD 100. The disk 120 or a plurality (not shown) of disks may be affixed to the spindle 124 with a disk clamp 128. The HDD 100 further includes an arm 132 attached to the HGA 110, a carriage 134, a voice-coil motor (VCM) that includes an armature 136 including a voice coil 140 attached to the carriage 134; and a stator 144 including a voice-coil magnet (not shown); the armature 136 of the VCM is attached to the carriage 134 and is configured to move the arm 132 and the HGA 110 to access portions of the disk 120 being mounted on a pivot-shaft 148 with an interposed pivot-bearing assembly 152.

With further reference to FIG. 1, in accordance with an embodiment of the present invention, electrical signals, for example, current to the voice coil 140 of the VCM, write signal to and read signal from the PMR head 110a, are provided by a flexible cable 156. Interconnection between the flexible cable 156 and the head 110a may be provided by an arm-electronics (AE) module 160, which may have an on-board pre-amplifier for the read signal, as well as other read-channel and write-channel electronic components. The flexible cable 156 is coupled to an electrical-connector block 164, which provides electrical communication through electrical feedthroughs (not shown) provided by an HDD housing 168. The HDD housing 168, also referred to as a casting, depending upon whether the HDD housing is cast, in conjunction with an HDD cover (not shown) provides a sealed, protective enclosure for the information storage components of the HDD 100.

With further reference to FIG. 1, in accordance with an embodiment of the present invention, other electronic components (not shown), including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the disk 120 that is affixed to the spindle 124 by the disk clamp 128; as a result, the disk 120 spins in a direction 172. The spinning disk 120 creates a cushion of air that acts as an air-bearing on which the air-bearing surface (ABS) of the slider 110b rides so that the slider 110b flies above the surface of the disk 120 without making contact with a thin magnetic-recording medium of the disk 120 in which information is recorded. The electrical signal provided to the voice coil 140 of the VCM enables the head 110a of the HGA 110 to access a track 176 on which information is recorded. Thus, the armature 136 of the VCM swings through an arc 180 which enables the HGA 110 attached to the armature 136 by the arm 132 to access various tracks on the disk 120. Information is stored on the disk 120 in a plurality of concentric tracks (not shown) arranged in sectors on the disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

Embodiments of the present invention also encompass HDD 100 that includes the HGA 110, the disk 120 rotatably mounted on the spindle 124, the arm 132 attached to the HGA 110 including the slider 110b including the head 110a. Therefore, embodiments of the present invention incorporate within the environment of the HDD 100, without limitation, the subsequently described embodiments of the invention for reducing or eliminating the dielectric material between transmission-line (TL) conductors to increase the signal bandwidth supported by the transmission-line (TL) conductors as further described in the following discussion. Similarly, embodiments of the present invention incorporate within the environment of the HGA 110, without limitation, the subsequently described embodiments of the invention for reducing or eliminating the dielectric material between transmission-line (TL) conductors to increase the signal bandwidth supported by the transmission-line (TL) conductors as further described in the following discussion.

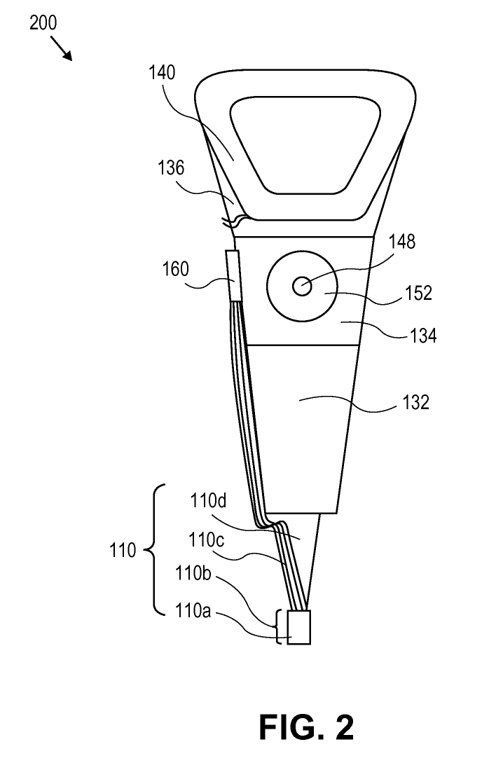

With reference now to FIG. 2, in accordance with an embodiment of the present invention, a plan view of a head-arm-assembly (HAA) including the HGA 110 is shown. FIG. 2 illustrates the functional arrangement of the HAA with respect to the HGA 110. The HAA includes the arm 132 and HGA 110 including the slider 110b including the head 110a. The HAA is attached at the arm 132 to the carriage 134. In the case of an HDD having multiple disks, or platters as disks are sometimes referred to in the art, the carriage 134 is called an “E-block,” or comb, because the carriage is arranged to carry a ganged array of arms that gives it the appearance of a comb. As shown in FIG. 2, the armature 136 of the VCM is attached to the carriage 134 and the voice coil 140 is attached to the armature 136. The AE 160 may be attached to the carriage 134 as shown. The carriage 134 is mounted on the pivot-shaft 148 with the interposed pivot-bearing assembly 152.

Reducing or Eliminating the Dielectric Materials Between Signal Conductors to Increase Bandwidth Support

Embodiments of the invention enable transmission-line (TL) conductors to support higher signal bandwidth than prior approaches. Transmission-line (TL) conductors according to embodiments of the invention may be used in a variety of different locations within a HDD. For example, transmission-line (TL) conductors of certain embodiments may electronically connect a transducer (which may be implemented in head 110a) to a read/write integrated circuit (IC) (which may be implemented in AE module 160. As another example, transmission-line (TL) conductors of other embodiments may electronically connect a read/write integrated circuit (IC) (which may be implemented in AE module 160 to flexible cable 160. Transmission-line (TL) conductors according to embodiments of the invention may be employed in a variety of different suspension interconnect structures or arrangements, including, for example, a coplanar interconnect structure or a bi-layer interconnect structure.

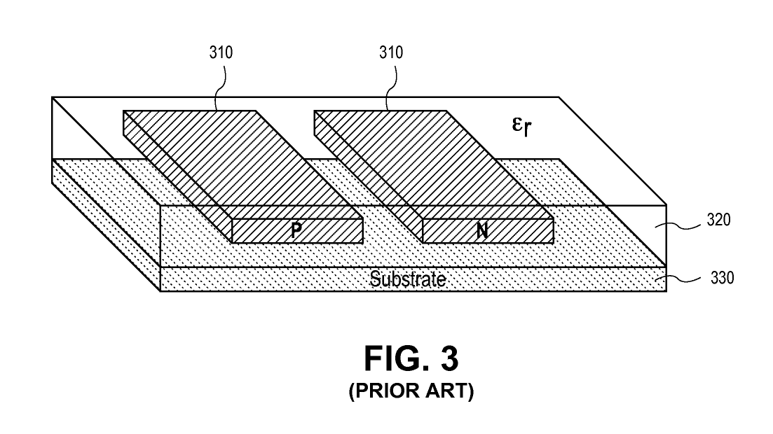

To understand how embodiments of the invention may be implemented, it may be helpful to understand how prior transmission-line (TL) conductors have been implemented. FIG. 3 is a cross-sectional view of a differential interconnect structure according to the prior art. As shown in FIG. 3, transmission-line (TL) conductors 310 are fully enclosed in dielectric layer 320 that is disposed on substrate layer 330. Substrate layer 330 may be formed using a poor conductor, such as stainless steel. Dielectric layer 320 may be formed using polyimide, which has a relative permittivity between 3 and 4 (εᵣ, ε=εᵣε₀, where ε₀=8.85×10⁻¹² F/m for vacuum). Transmission-line (TL) conductors 310 may be formed using a conductive material, such as a copper alloy.

As transmission-line (TL) conductors carry higher signal frequencies, such as 1 gigahertz or greater, the dielectric losses (tan δ, where tan ε=ε″/ε′, and ε=ε′−jε″) begin to dominate the attenuation of the signal transfer, as the dielectric material adjacent to the transmission-line (TL) conductor 310, which typically insulates transmission-line (TL) conductors 310, itself becomes conductive. This causes the dielectric material to act as an electrical shunt and energy carried by transmission-line (TL) conductors 310 is dissipated. To address this issue, embodiments of the invention (not depicted in FIG. 3 and explained in further detail below) advantageously remove as much of the dielectric material adjacent to or enclosing the transmission-line (TL) conductors as possible by using an air dielectric.

For purposes of providing a clear description, FIGS. 3-5B depict two different transmission-line (TL) conductors. Each of the two different transmission-line (TL) conductors in these figures are either labeled “N” or “P,” signifying that transmission-line (TL) conductors 310 are operating in a differential mode by carrying complimentary signals. While not depicted in FIGS. 3-5B, embodiments of the invention may also be employed where transmission-line (TL) conductors operate in a single-ended mode, i.e., where each transmission-line (TL) conductor carries a voltage varying representing a signal and another transmission-line (TL) conductor carries a reference voltage (such as ground).

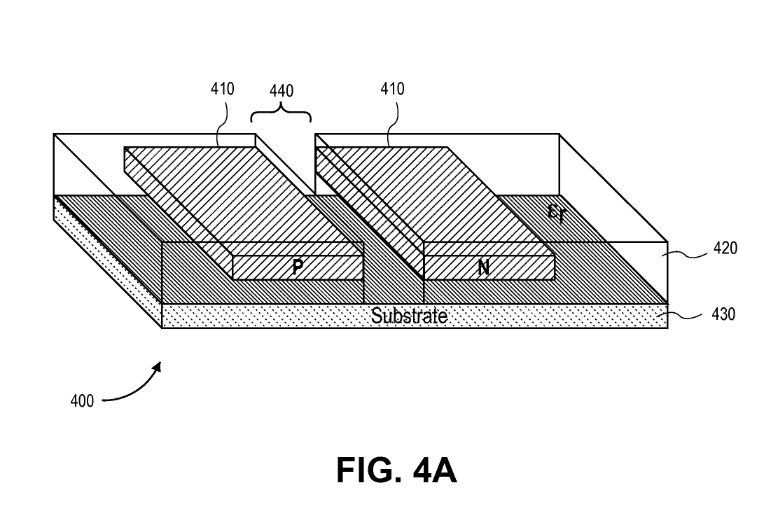

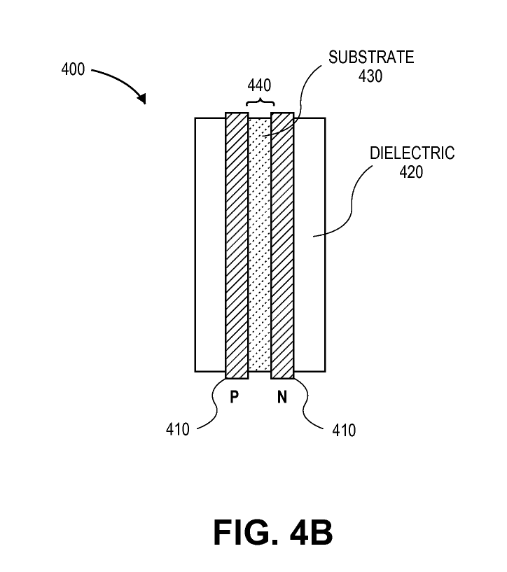

One approach for employing an air dielectric is depicted in FIG. 4A, which is a cross-sectional view of an interconnect structure having an air spine. The term “air spine” refers to area between adjacent transmission-line (TL) conductors where the dielectric material of dielectric layer 420 is removed, thereby leaving air in-between the adjacent transmission-line (TL) conductors. For example, the interconnect structure shown in FIG. 4A comprises air spine 440 between transmission-line (TL) conductors 410. The dielectric in air spine 440 is air (as opposed to the dielectric material comprising dielectric layer 420, which may be polyimide). The location of air spine 440 corresponds to where the concentration of the electric field is greatest, namely the area between the adjacent transmission-line (TL) conductors 410.

FIG. 4B is a top view of the interconnect structure of FIG. 4A. While FIGS. 4A and 4B depicts air spine 440 as encompassing the entirety of the area between the transmission-line (TL) conductors, in other embodiments of the invention (not depicted), air spine 440 may be implemented such that a certain amount of the dielectric material comprising dielectric later 420 may remain in the area between transmission-line (TL) conductors, although the amount of dielectric material remaining between the transmission-line (TL) conductors should not be sufficient to reduce the bandwidth of the transmission-line (TL) conductors 410.

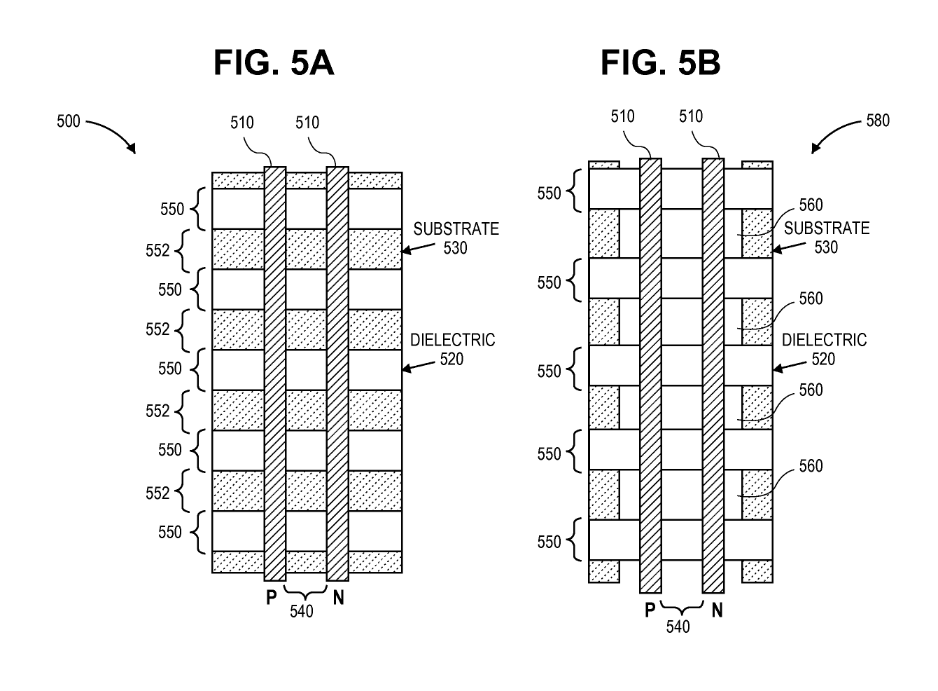

FIG. 5A is a top view of an interconnect structure 500 according to another embodiment of the invention. Interconnect structure 500 of FIG. 5A has an air spine 540 similar to air spine 440 of FIG. 4B. However, the interconnect structure 500 also has a plurality of cross ties 550 formed out of the dielectric material that comprises the dielectric layer. As shown in FIG. 5A, the area adjacent to the plurality of transmission-line (TL) conductors 510 alternates between cross ties 550 and a sequence of air gaps 552 along the direction of travel of signals carried by plurality of transmission-line (TL) conductors 510.

In the embodiment of FIG. 5A, the sequence of air gaps 552 which are interspersed around plurality of transmission-line (TL) conductors 510 are (a) of relatively equal size and shape, and (b) disposed in regular intervals along the plurality of transmission-line (TL) conductors. However, this need not be the case for all implementations. For example, in certain implementations, air gaps 550 may have a variety of different shapes and sizes and/or may be disposed in irregular intervals. Indeed, the only limitation to the dimensions of air gaps 550 is that the cross ties 550 must provide sufficient structural support to the transmission-line (TL) conductors 510, as the transmission-line (TL) conductors 510 traverse through the cross ties 550 without making contact with the substrate layer. While cross ties 550 may be formed at a variety of different angles relative to transmission-line (TL) conductors 510, most implementations will position cross ties 550 perpendicular to transmission-line (TL) conductors 510, as shown in FIG. 5A.

The use of cross ties 550 enables the transmission-line (TL) conductors 510 to support a greater amount of signal bandwidth, as the sequence of air gaps 550, naturally resulting from use of cross ties 550, reduces the dielectric material surrounding, enclosing, or adjacent to the transmission-line (TL) conductors 510, which minimizes the ability of the dielectric material to act as an electrical shunt. Cross ties 550 also provide sufficient structural support to transmission-line (TL) conductors 510 to ensure that they are fixed in desired positions.

In addition to the use of air spines and cross ties, certain embodiments of the invention also use substrate windowing to reduce the dielectric material enclosing, surrounding, or adjacent to the transmission-line (TL) conductors. FIG. 5B is a top view of an interconnect structure 580 having air spine 540, dielectric cross ties 550, and substrate windows 560 according to an embodiment of the invention. As shown by FIG. 5B, substrate windowing refers to an approach where one or more air gaps (or substrate windows 560) are disposed in the substrate layer underneath a portion of plurality of transmission-line (TL) conductors 510. Substrate windows 560 reduce the dielectric material surrounding, enclosing, or adjacent to transmission-line (TL) conductors 510, which minimizes the ability of the dielectric material to act as an electrical shunt.

Substrate windows 560 may have a variety of different shapes and sizes. For example, substrate windows 560 may be of relatively equal size and shape and be disposed in regular intervals within the substrate layer. Alternately, substrate windows 560 may correspond to a small number (or even just one) of air gaps disposed in the substrate layer that are disposed underneath the transmission-line (TL) conductors. For example, a small number (or even just one) substrate window may result in the absence of the majority of the substrate layer underneath the plurality of transmission-line (TL) conductors.

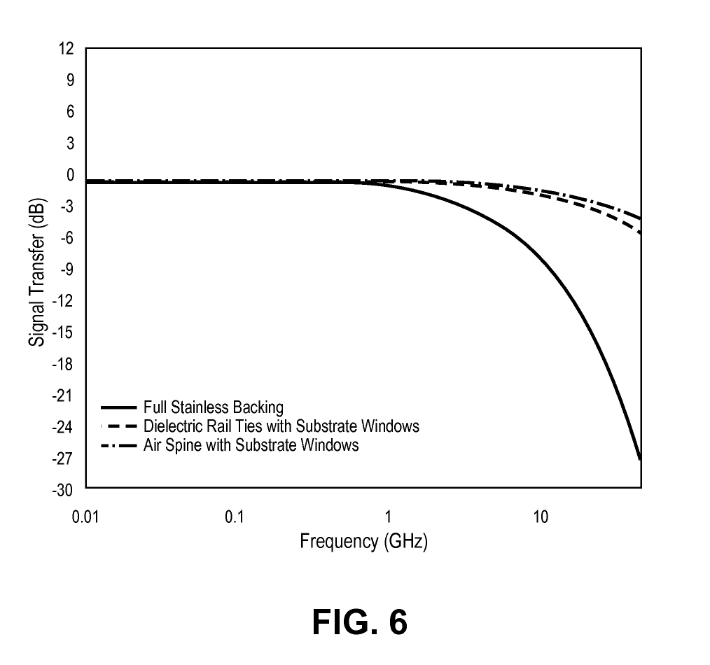

FIG. 6 is a graph comparing the frequency response for different approaches according to embodiments of the invention. FIG. 6 illustrates the frequency response and benefits of utilizing embodiments of the invention in suspension interconnects. As shown by FIG. 6, reducing or removing the dielectric material surrounding, enclosing, or adjacent to the transmission-line (TL) conductors increases the ability to the transmission-line (TL) conductors to carry higher frequency signals. As shown in FIG. 6, the best results are achieved by using an air spine with substrate windows. By using embodiments of the invention discussed herein, signal frequencies up to at least 30 gigahertz may be carried by transmission-line (TL) conductors.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A suspension interconnect for use in a hard-disk drive, comprising:
a substrate layer;
a dielectric layer disposed on the substrate layer, wherein the dielectric layer comprises a dielectric material; and
a plurality of transmission-line (TL) conductors disposed within the dielectric layer,
wherein an air gap exists in the dielectric layer between adjacent transmission-line (TL) conductors in the plurality of transmission-line (TL) conductors,
wherein the area adjacent to the plurality of transmission-line (TL) conductors, along the direction of travel of signals carried by the plurality of transmission-line (TL) conductors, alternates between the dielectric material and a sequence of air gaps, and
wherein the substrate layer comprises one or more air gaps underneath a portion of the plurality of transmission-line (TL) conductors.

2. The suspension interconnect of claim 1, wherein the plurality of transmission-line (TL) conductors extend from a transducer to a read/write integrated circuit (IC).

3. The suspension interconnect of claim 1, wherein the plurality of transmission-line (TL) conductors extend from a read/write integrated circuit (IC) to a flexible cable.

4. The suspension interconnect of claim 1, wherein the sequence of air gaps which are interspersed around the plurality of transmission-line (TL) conductors are (a) of relatively equal size and shape, and (b) disposed in regular intervals along the plurality of transmission-line (TL) conductors.

5. The suspension interconnect of claim 1, wherein the one or more air gaps in the substrate layer result in the absence of the majority of the substrate layer underneath the plurality of transmission-line (TL) conductors.

6. The suspension interconnect of claim 1, wherein the plurality of transmission-line (TL) conductors have a bandwidth of at least 10 gigahertz.

7. The suspension interconnect of claim 1, wherein the plurality of transmission-line (TL) conductors operate in a single-ended mode.

8. The suspension interconnect of claim 1, wherein the plurality of transmission-line (TL) conductors operate in a differential mode.

9. The hard-disk drive of claim 1, wherein the suspension interconnect is either a coplanar interconnect structure or a bi-layer interconnect structure.

10. The hard-disk drive of claim 1, wherein the sequence of air gaps in the dielectric layer form a plurality of cross ties that provide structural support for the plurality of transmission-line (TL) conductors, and wherein the plurality of cross ties are perpendicular to the plurality of transmission-line (TL) conductors.

11. The hard-disk drive of claim 1, wherein the substrate is stainless steel and the dielectric material is a polyimide with a relative permittivity between 3 and 4 F/m.

12. A hard-disk drive, comprising:
a magnetic read/write head coupled to a suspension by a plurality of transmission-line (TL) conductors, wherein the plurality of transmission-line (TL) conductors are disposed within a dielectric layer of the suspension;
a magnetic-recording disk rotatably mounted on a spindle;
a drive motor having a motor shaft attached to the spindle for rotating the magnetic-recording disk; and
a voice-coil motor configured to move the magnetic read/write head to access portions of the magnetic-recording disk,
wherein an air gap exists in the dielectric layer between adjacent transmission-line (TL) conductors in the plurality of transmission-line (TL) conductors,
wherein the area adjacent to the plurality of transmission-line (TL) conductors, along the direction of travel of signals carried by the plurality of transmission-line (TL) conductors, alternates between the dielectric material and a sequence of air gaps, and
wherein a substrate layer, upon which the dielectric layer is mounted, comprises one or more air gaps underneath a portion of the plurality of transmission-line (TL) conductors.

13. The hard-disk drive of claim 12, wherein the plurality of transmission-line (TL) conductors extend from a transducer to a read/write integrated circuit (IC).

14. The hard-disk drive of claim 12, wherein the plurality of transmission-line (TL) conductors extend from a read/write integrated circuit (IC) to a flexible cable.

15. The hard-disk drive of claim 12, wherein the sequence of air gaps which are interspersed around the plurality of transmission-line (TL) conductors are (a) of relatively equal size and shape, and (b) disposed in regular intervals along the plurality of transmission-line (TL) conductors.

16. The hard-disk drive of claim 12, wherein the one or more air gaps in the substrate layer result in the absence of the majority of the substrate layer underneath the plurality of transmission-line (TL) conductors.

17. A persistent storage medium, comprising:
a suspension means coupled to a plurality of transmission-line (TL) conductors, wherein the plurality of transmission-line (TL) conductors are disposed within a dielectric layer of the suspension means;
a read/write means mounted on the suspension means, wherein the read/write means are also coupled to the plurality of transmission-line (TL) conductors; and
a disk rotatably mounted on a spindle,
wherein an air gap exists in the dielectric layer between adjacent transmission-line (TL) conductors in the plurality of transmission-line (TL) conductors,
wherein the area adjacent to the plurality of transmission-line (TL) conductors, along the direction of travel of signals carried by the plurality of transmission-line (TL) conductors, alternates between the dielectric material and a sequence of air gaps, and
wherein a substrate layer, upon which the dielectric layer is mounted, comprises one or more air gaps underneath a portion of the plurality of transmission-line (TL) conductors.

18. The persistent storage medium of claim 17, wherein the plurality of transmission-line (TL) conductors extend from a transducer in the read/write means to a read/write integrated circuit (IC).

19. The persistent storage medium of claim 17, wherein the plurality of transmission-line (TL) conductors extend from a read/write integrated circuit (IC) to a flexible cable.

20. The persistent storage medium of claim 17, wherein the sequence of air gaps which are interspersed around the plurality of transmission-line (TL) conductors are (a) of relatively equal size and shape, and (b) disposed in regular intervals along the plurality of transmission-line (TL) conductors.
